(19) United States
(12) Patent Application Publication
(10) Pub. No.: US 2012/0294662 A1
(43) Pub. Date: Nov. 22, 2012

(54) Method for Controlling the Web Tension in a Web Processing Machine

(75) Inventors: Holger Schnabel, Veitshoechheim (DE); Stephan Schultze, Lohr-Wombach (DE); Mario Goeb, Wuerzburg (DE)

(73) Assignee: Robert Bosch GmbH, Stuttgart (DE)

(21) Appl. No.: 13/470,993

(22) Filed: May 14, 2012

(30) Foreign Application Priority Data
May 17, 2011 (DE) 10 2011 101 842.9

(51) Int. Cl. B41J 11/42

(52) U.S. Cl. 400/618

(57) ABSTRACT

A method for controlling the web tension of a product web in a web processing machine includes reducing the effects of the web tension control on the web stretch before an impending change in at least one parameter influencing the web tension.

This application claims priority under 35 U.S.C. §119 to patent application no. DE 10 2011 101 842.9, filed on May 17, 2011 in Germany, the disclosure of which is incorporated herein by reference in its entirety.

### BACKGROUND

The present disclosure relates to a method for controlling the web tension in a web processing machine.

Although, in the following text, reference is primarily made to web-fed printing presses, the disclosure is not restricted thereto but instead is directed to all types of processing machines in which a product web or material web is processed (“web processing machine” below). The disclosure can, however, be used in particular in web-fed printing presses, such as newspaper printing presses, commercial printing presses, gravure printing presses, packaging printing presses, digital printing presses or valuable document printing presses, and also in other web processing machines, such as bag-making machines, envelope-making machines or packaging machines. The product web can be formed from paper, fabric, paperboard, plastic, metal, rubber, in the form of a film or foil and so on.

In relevant web processing machines, in particular web-fed printing presses, a product web is moved along driven shafts (web transport shafts or devices), such as pull rolls or feed rolls, and non-driven shafts (such as deflection, guide, drying or cooling rolls). At the same time, the product web is processed (e.g. printed, punched, cut, folded and so on) by means of normally likewise driven processing devices (such as printing units, cutting units).

In such a machine, a longitudinal and/or lateral register (longitudinal register—in the web running direction, lateral register—transversely with respect to the web running direction) is usually controlled. This is used to control the positions of the processing units of the individual processing devices (e.g. the positions of individual, differently colored printed images) in relation to one another and is carried out, for example, by means of what is known as an angular adjustment of the processing device to be corrected. In printing presses, the web tension is often also controlled (for example by adjusting the speed of a transport device), in order to achieve an optimum printed result.

Known controllers, such as proportional controllers, derivative controllers, integral controllers and so on and arbitrary combinations thereof include controller parameters which have to be set. Conventional controller parameters are the proportional gain K_{P}, the integral gain K_{I}, the differential gain K_{D}, the integral time T_{N}, the derivative time T_{V}, delays T and so on.

The applicant has previously developed a number of methods in order to simplify the configuration of web tension controllers:

For instance, EP 1 790 601 A2 illustrates the fact that controller parameters can be determined as a function of product web parameters (e.g. modulus of elasticity), machine parameters (e.g. product web length, product web speed or moment of inertia) and operating parameters (e.g. control deviation).

DE 10 2008 035 639 A1 illustrates the fact that, in addition to these variables, there are also dead times in the controlled system and these can be used for determining the controller parameters.

In DE 10 2009 019 624 A1, controller configuration as a function of at least one parameter characterizing the product web, such as the modulus of elasticity and/or the cross section, at least one parameter characterizing the processing machine, such as the web speed and/or the section length, and at least one, in particular constant (i.e. not dependent on web speed) and/or speed-dependent dead time, such as a transit time and/or a measuring time, is described. It is also disclosed that the configuration is carried out regularly, so that it is possible, for example, to react to the change in the modulus of elasticity automatically by adapting the controller parameters. In this way, the most optimum controller parameters possible are to be predefined at every time. Furthermore, it is proposed to optimize the control with respect to the disturbance behavior, so that the highest possible control loop dynamics in relation to disturbances in the web tension actual value are achieved (i.e. a disturbance in the web tension actual value is to be controlled out as dynamically (=rapidly) as possible). It is therefore possible to achieve the situation where a web tension actual value deviates little from the associated web tension set point.

However, it has been observed (cf. publication “Online-Rekonstruktion von Elastizitatsmodul-Anderungen der Papierbahn in Rollendruckmaschinen” [Online Reconstruction of Changes in Modulus of Elasticity of the Paper Web in Web-fed Presses], paper given by Prof. Brandenburg at SPS/IPC/Drives 2008) that large register deviations occur in web-fed presses, in particular at a reel change. This was attributed, inter alia, to an abrupt change in the modulus of elasticity E. This disturbance is introduced into the machine and, as it passes each clamping point, excites compensation processes which lead to web tension, color and cut register errors. In the process, large register deviations occur, which cannot be controlled out rapidly either by an existing register control system. Because of the long web path from the point at which the disturbances arise, the unwinder, as far as the cutting cylinder of the folder, the resultant overall register deviation can become particularly large. Above all in commercial offset presses, because of the required high cut position accuracy, this leads to relatively high numbers of rejects but will presumably play an increasingly important role in the future, even in newspaper printing presses.

It is therefore desirable to reduce the register deviations caused by abrupt web tension changes.

### SUMMARY

Starting from this prior art, the present disclosure proposes a method for operating a web processing machine. Advantageous refinements are the subject matter are also described herein.

An abrupt change in the modulus of elasticity E in the case of a (as in the prior art sufficiently highly or dynamically) controlled (that is to say a substantially constant) web tension s leads to a corresponding abrupt change in the web stretch e on account of the known relationship s=e·E. This change in the stretch propagates from the place of change in the modulus of elasticity over the entire machine. During this compensation phase, there are thus different stretch relationships in the individual processing devices, which lead to different processing positions of the same in relation to one another and therefore to register deviations.

The disclosure now comprises the measure, before an impending change in at least one parameter influencing the web tension (this is usually a parameter characterizing the product web, in particular the modulus of elasticity E) which, in the uncontrolled case, would lead to an abrupt change in the web tension (this is because here, the stretch would remain constant on the basis of an unchanged machine speed), of reducing the effects of the web tension control on the web stretch, in particular of reducing the control loop dynamics of the web tension controller.

As a result, the change in the parameter influencing the web tension certainly leads to a greater change in the web tension as compared with a conventional web tension control system but, as a result, to a smaller change in the web stretch.

For the purpose of implementation, the disclosure preferably makes use of a reduction in the influence or the dynamics of the web tension control, for example by means of a suitable change in the controller parameters (e.g. reducing that of K_{P}), and activating limits in the controller (in particular for the controller output variable and/or the control difference, that is to say the input variable) or by adapting the set point. In this case, the web tension set point can be changed in such a way that a change in stretch remains small. The new set point can be determined, for example, by the web tension resulting after the change without any control being determined (for example by the changing material parameter being used and the web tension that then results being calculated therefrom for a constant web stretch). Alternatively, the web tension resulting after the change with the web tension control system switched off can also be measured and used as a new web tension set point. The web tension control system would then be switched on again with the new set point. Starting from the new web tension set point, the current set point will then be set back to the original value with adequately low dynamics.

Simply switching off the web tension control system cannot eliminate the problem, since then the changes in stretch and therefore the register errors occur when the web tension control system is subsequently switched on.

In principle, as a result of the reduced dynamics of the web tension controller, the result is a change in the actual web tension (which can be kept substantially constant given a relatively large influence of the web tension control, for example with high or dynamic controller settings). However, the disclosure is based on the finding that the longitudinal register is influenced less by web tension than by web stretch. By means of reducing the web tension control dynamics, the change in stretch on account of a change in the controller output variable will also take place with lower dynamics.

The less dynamic changes in stretch lead to less dynamic register deviations, which can easily be controlled out by a register control system, so that rejects can be reduced or completely avoided. A less intensive intervention of a web tension controller will lead to the period of the compensation process being lengthened but, in conjunction with a register controller of which the control dynamics in the closed control loop are greater than or equal to the dynamics of the web tension controller, the maximum magnitude of the register deviation decreases. The effect of the web tension control on the web stretch will preferably be reduced such that the magnitude of the register deviation that occurs does not exceed an upper threshold value, so that, preferably, just no rejects occur.

The disclosure creates a possible way, given knowledge of an impending change in at least one parameter influencing the web tension, of taking measures in advance in order to keep rejects low. The time of a change is known in advance, for example in the case of a flying reel change, a change in the input of ink or damping solution into the material web or a change in the temperature in the machine. The changeover in the web tension control can therefore preferably be carried out automatically within the control device.

The change in the input of ink or damping solution into the material web occurs in printing processes comprising offset printing, gravure printing, flexographic printing, etc, for example as a result of “print on”/“print off” impression settings or as a result of changes in the quantity of ink or water supplied during printing.

In digital printing presses, the quantity of ink in one format can result from another printed image. Digital printing presses are distinguished, for example, by the fact that different products can be printed directly from format to format without stopping the machine. This means that here, as a result of ink changes, there is also an abrupt change in the product web material characteristics.

In addition, the temperature in the machine can change relatively abruptly if, for example, the heating output of the dryers can be changed very dynamically or if the drying process of the ink and/or the product web can be changed relatively quickly (e.g. switching on an LED dryer).

The disclosure leads to a deliberate reduction in the dynamics of the web tension control. However, under normal operating conditions or for example when the machine is being run up, high dynamics prove to be advantageous, in order to achieve a short settling time of the web tension controller and to produce less rejects there. For this reason, following the change in the at least one parameter influencing the web tension, the dynamics of the web tension controller are increased again or set back to the normal state. This can be done as a function of time or when a register deviation falls below a threshold value. Here, the changeover is expediently not carried out abruptly but continuously or in small steps. For instance, the controller parameters are interpolated linearly between reduced and high dynamics in order to achieve a smooth transition.

Preferably, at least during the control with a reduced influence, smoothing of the web tension actual value is performed. Smoothing can be implemented, for example, with a PT1 element by the time constant T₁ being increased appropriately. A greater smoothing leads to an additional delay (dead time) in the system and reduces the possible control loop dynamics. Depending on the reduction in the control loop dynamics, the smoothing time constant T₁ can be adapted automatically, increased in this case. Under the assumption that the dynamics of the closed control loop are inversely proportional to actual value smoothing, in the case of low predefined control loop dynamics, smoothing elements can be introduced or already existing smoothing time constants can be increased without the control loop becoming unstable as a result. This means that, in particular, broadband noise disturbances on a web tension actual value can be counteracted. Undesired fluctuations in the controller output variable can be reduced as a result.

According to a further preferred embodiment, before the impending change in the at least one parameter influencing the web tension, the control loop dynamics of the web tension controller are adapted to the control loop dynamics of the register controller. For example, the bandwidth of the closed web tension control loop can be set to a fixed factor (e.g. 1/10) of the bandwidth of the closed register control loop by the controller parameters of the web tension controller being adapted (reduced) accordingly. This results in a transient behavior in the longitudinal register that is comparable independently of the control loop dynamics of the register control loop. As a result of the reduction in the controller parameters of the web tension controller, the control loop dynamics of the register controller dominate. This means that the web tension controller controls the abrupt change in the modulus of elasticity and thus of the web tension slowly back to the set point; on account of the higher dynamics of the register controller, the latter controls out the changes in stretch produced as a result, without rejects being produced.

A computing unit according to the disclosure, e.g. a control device of a printing press, is set up, in particular by programming, to carry out a method according to the disclosure.

In addition, the implementation of the disclosure in the form of software is advantageous, since this permits particularly low costs, in particular when an executing computing unit is also used for further tasks and is therefore present in any case. Suitable data carriers for providing the computer program are in particular floppy disks, hard drives, flash memories, EEPROMs, CD-ROMs, DVDs and many more. Downloading a program via computer networks (Internet, Intranet and so on) is also possible.

Further advantages and refinements of the disclosure can be gathered from the description and the appended drawing.

It goes without saying that the features mentioned above and still to be explained below can be used not only in the respectively specified combination but also in other combinations or on their own without departing from the scope of the present disclosure.

The disclosure is illustrated schematically in the drawing by using exemplary embodiments and will be described extensively below with reference to the drawing.

### BRIEF DESCRIPTION OF THE DRAWINGS

FIG. 1 shows a schematic illustration of a processing machine configured as a printing press, for which the method according to the disclosure is suitable;

FIG. 2 uses a schematic block circuit diagram to show an example of a web tension control loop; and

FIG. 3 shows a flow chart of a particularly preferred embodiment of the method according to the disclosure.

### DETAILED DESCRIPTION

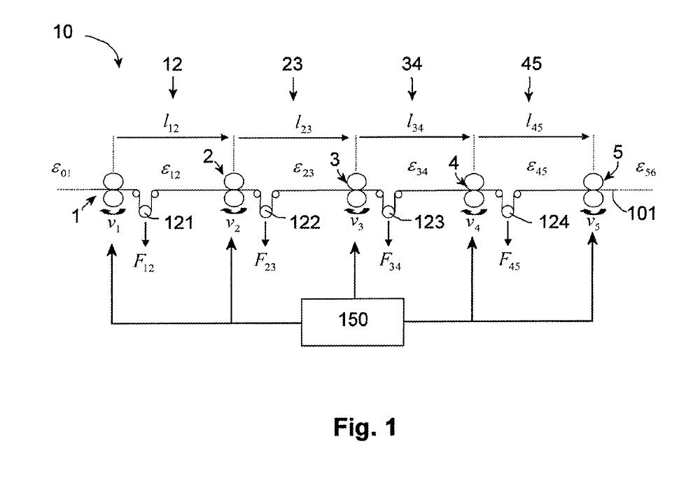

FIG. 1 illustrates a schematic detail from a printing press 10, in which a material web 101 is transported through five clamping points, formed as printing units 1 to 5 here, and is processed. A web tension section is formed in each case between two adjacent clamping points. For example, one web tension section 12 is delimited by the printing units 1 and 2, one web tension section 23 by the printing units 2 and 3, one web tension section 34 by the printing units 3 and 4, and one web tension section 45 by the printing units 4 and 5. Instead of printing units, transport units, such as infeed or outfeed unit, can also be involved.

Furthermore, the printing press has web tension sensors, formed as force transducers 121 to 124 here, for determining the tensile force F in the respective web tension sections. The physical parameters, specifically the length l, the stretch e and the tensile force F of the individual web tension sections are likewise indicated in the figure. Assuming a usually constant web cross section, the tensile force F is proportional to the web tension s.

In the illustration shown, the tensile force and therefore the web tension is set via the peripheral speeds v1 to v5 of the printing units 1 to 5, which can be changed by a web tension control device formed as a computing unit or computer 150. In order to influence the web tension, for example in the web tension section 34, two strategies are known. In the upstream strategy, the printing unit 3 (and, optionally, printing units located upstream thereof) is adjusted, and, in the downstream strategy, the printing unit 4 (and, optionally, following printing units) is adjusted. An increase in the speed of the upstream clamping point effects a steady reduction in the web tensile force, and an increase in the speed of the downstream clamping point effects a steady rise in the web tensile force in this web tension section.

In order to carry out the web tension control, the tensile force values measured by the sensors 121 to 124 are fed to a device for web tension control (what is known as a web tension or draw controller) within the computing unit 150. Depending on the control deviation (deviation between set point and actual value), the draw controller then controls the speeds v1 to v5, for example by influencing a transmission factor (what is known as a fine adjustment) between machine speed (which is usually predefined by a virtual master shaft) and transport roll.

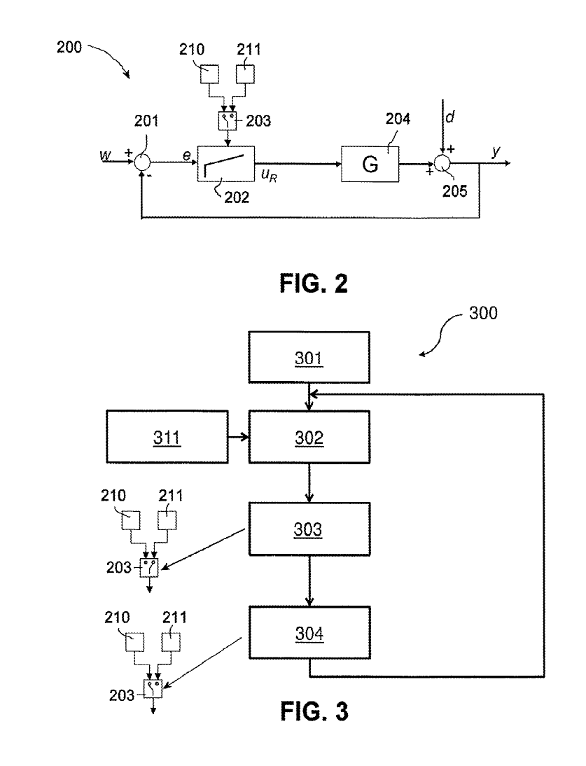

In FIG. 2, the web tension control on which the disclosure is based is illustrated schematically using a control loop 200. The control loop can be based, for example, on a printing press according to FIG. 1. The reference variable w (for example the tensile force set point Fₛₚ) is fed to a comparison element or subtraction element 201, to which the controlled variable y (for example the tensile force F_{act} which, as mentioned, is proportional to the web tension) is also fed. The resultant control difference or control deviation e is fed to a web tension control element 202 which, in the present case, is configured as a PI element with a proportional gain K_{P} and an integral time T_{N}. Without restriction, the control element can also be implemented as P, PD or PID element or as another controller, such as a state controller.

According to the illustrated embodiment of the disclosure, different controller parameters can be fed to the control element 202 by a switch element 203. For this purpose, the switch element 203 can feed to the control element 202 a first set 210 or a second set 211 of controller parameters which determine the influence of the web tension control. For example, the first set of controller parameters can lead to dynamic web tension control for the usual operation, whereas the second set leads to less dynamic web tension control for the imminent abrupt changes in the web tension (for example on account of a change in the modulus of elasticity).

On the basis of the controller parameters fed thereto, the control element 202 calculates a controller output variable u_{R}, which is fed to the controlled section (G) 204. Downstream of the controlled section, a disturbance variable d acts (in the example shown likewise additively via a summing element 205), which changes the control variable or the actual value y. This is measured, for example by the aforementioned sensors, and fed back to the comparison element 201 again. The controller output variable u_{R} can be a fine adjustment fa which influences the rotational speed of the device to be controlled.

FIG. 3 illustrates a flow chart of a method according to the disclosure, designated overall by 300. In step 301, the processing machine is in a defined state (“normal operation”), in which the web tension control device is loaded with a first parameter set, e.g. the set 210.

In step 302, the method waits for an impending change 311 in at least one parameter influencing the web tension, usually the modulus of elasticity E. Such a change occurs predictably for example at a reel change or upon other events already explained above. Accordingly, the time of the change is known within the control system, so that the changeover can be carried out automatically. It goes without saying, however, that the method according to the disclosure can in principle be informed of a corresponding change in any desired manner. For instance, separate data lines can be used for this purpose or a user input, which is made in an appropriate device, can be included.

In step 303, the system performs a changeover in the controller dynamics, in the example of FIG. 1 by changing the controller parameters 210 to 211, for example. The parameters can be taken from a look-up table or database, for example. However, a corresponding automatic calculation of the parameter sets can also be carried out.

The newly chosen parameters are maintained until a suitable condition is fulfilled and, in step 304, the earlier parameters 210 are again predefined. The condition can be in particular the expiry of a time interval or the reducing of the register deviation or web tension deviation below a predefined threshold value. The system then returns to the waiting state 302 again and waits for a new change.

Only exemplary embodiments of the disclosure are illustrated in the figure shown. In addition, any other embodiment is conceivable without departing from the scope of this disclosure.

What is claimed is:

1. A method for controlling the web tension of a product web in a web processing machine, comprising:
reducing the effects of the web tension control on the web stretch before an impending change in at least one parameter influencing the web tension.

2. The method as claimed in claim 1, wherein the effects of the web tension control on the web stretch are reduced only when the impending change in the at least one parameter influencing the web tension exceeds a predetermined threshold value.

3. The method as claimed in claim 1, wherein the at least one parameter influencing the web tension is a parameter characterizing the product web, in particular the modulus of elasticity.

4. The method as claimed in claim 1, wherein the effects of the web tension control on the web stretch are reduced by changing the controller parameters, limiting the controller output variable and/or the control deviation, changing the set point and/or changing the bandwidth of the closed web tension control loop.

5. The method as claimed in claim 4, wherein the new set point used is the actual value resulting after the change without control.

6. The method as claimed in claim 1, wherein:
the effects of the web tension control on the web stretch are increased again when a predetermined condition is fulfilled, and
the predetermined condition is the expiry of a predetermined time interval.

7. The method as claimed in claim 1, wherein, at least during the control with reduced effects of the web tension control on the web stretch, changed or additionally added smoothing of the actual value is carried out.

8. The method as claimed in claim 1, wherein, before the impending change in the at least one parameter influencing the web tension, the control loop dynamics of the web tension control loop are set to a value less than the control loop dynamics of an existing register control loop.

9. The method as claimed in claim 1, wherein the effects of the web tension control on the web stretch are reduced such that a register deviation resulting from the change in the at least one parameter influencing the web tension remains below a predefined threshold value.

10. The method as claimed in claim 1, wherein a computing unit is set up to carry out the method.

11. A web processing machine comprising:
a computing unit configured to control the web tension of a product web in a web processing machine by reducing the effect of the web tension control on the web stretch before an impending change in at least one parameter influencing the web tension.
